(19) United States
(12) Patent Application Publication
(10) Pub. No.: US 2014/0210327 A1
(43) Pub. Date: Jul. 31, 2014

(54) HARDWARE SYSTEM FOR GUIDING THE CLOSURE FLAP OF A FURNITURE PIECE

(71) Applicant: Robert Schimansky, Stephanskirchen (DE)

(72) Inventor: Robert Schimansky, Stephanskirchen (DE)

(73) Assignee: STEELCASE WERNDL AG, Rosenheim (DE)

(21) Appl. No.: 14/237,229

(22) PCT Filed: Aug. 2, 2012
(86) PCT No.: PCT/EP2012/003305

§ 371 Date: Feb. 5, 2014

(30) Foreign Application Priority Data
Aug. 5, 2011 (DE) 10 2011 109 552.0

(51) Int. Cl. A47B 96/00; E05D 15/00; E06B 3/50

(52) U.S. Cl. CPC A47B 96/00; E06B 3/50; E05D 15/00
USPC 312/317.1; 49/414

(57) ABSTRACT

The present invention provides an improved hardware system for guiding a closure flap (200) of a furniture piece. The hardware system according to the invention comprises a damping unit (120, 122) that is embedded in an end region (100) of a hardware body (100) in the hardware body (100) or substantially parallel to an end region of a guide slot (110) in a side wall of the furniture piece. A guide pin (210a) arranged in a side region of the closure flap (200) can be brought into contact with the damping unit (120, 122) and a weight tome of the closure flap exercised via the guide pin (210a) can be applied to the damping unit (120, 122) across a damping distance when the closure flap (200) is transferred into an end position, and in, doing so exercises a counter-force on the guide pin (210a), said force being lower than the weight-force exercised by the guide pin (210a) on the damping unit (120, 122).

The present invention relates to a fitting system for guiding a closure flap of a piece of furniture according to the preamble of claim 1.

Corresponding fitting systems have long been known and are usually arranged or fastened on inner faces of the piece of furniture. The known fitting systems usually comprise a linkage construction, by means of which the closure flap is coupled to the piece of furniture.

The piece of furniture is usually a cupboard or a cupboard unit, for example a hanging cupboard. However, the cupboard may also be part of a cupboard system comprising a plurality of cupboard modules, which system has a plurality of openings which can each be closed by means of corresponding closure flaps. The piece of furniture may also be for example a hanging cupboard of a desk underneath a desk leaf, or a container.

In the fitting systems known from the prior art, a damping device may be provided, by means of which the end phase of the movement of the closure flap is damped. Owing to corresponding damping of the movement of the closure flap, the closure flap is brought gently into its end position, thereby reducing the impact speed of the closure flap on the rest of the body of the piece of furniture, such that the noise development and the loading for the piece of furniture and for the closure flap are reduced.

Since the known fitting systems are placed on the inner faces of side walls of pieces of furniture, this results in a loss of storage space inside the piece of furniture or inside the cupboard. Production of the fitting systems is also complex and cost-intensive owing to the complicated linkage constructions.

A problem addressed by the present invention is therefore that of providing an improved yet simple fitting system which results in only slight or no loss of storage space inside the piece of furniture or the cupboard, is easy to produce and has only low assembly costs.

According to the invention, this problem is solved by the features indicated in claim 1. Advantageous configurations of the invention are indicated in the dependent claims.

The fitting system according to the invention is characterised in that, in the region of an end of a fitting body which is a component of the fitting system, a damping device is embedded in the fitting body or in the wall of a piece of furniture, substantially parallel to an end region of a guide slot of the fitting body. A guide pin which is provided in a side region of the closure flap can be brought into contact with the damping device, and a weight of the closure flap, exerted via the guide pin, can be applied to the damping device over a damping distance when the closure flap is transferred into an end position. The damping device exerts a counterforce on the guide pin, which counterforce is smaller than the weight exerted on the damping device by the guide pin.

By means of the fitting system according to the invention, which can be embedded entirely or at least predominantly in the wall, in particular side wall, of the piece of furniture, the storage space of the piece of furniture is reduced only to a small degree or not at all. In addition, the closure flap can be moved into its end position in a damped, that is to say braked, manner, in particular as a result of its weight alone. This allows a very gentle termination of the movement and a virtually silent transfer of the closure flap into its end position. This end position is preferably the closed position, but can also be the open position. The costs of the fitting system can be kept low. Because the guide pins arranged in the side regions of the closure flap are guided in the angled or bent guide slot, a complicated linkage between the closure flap and the fitting systems is not necessary. Since no linkage is used to couple the fitting system to the closure flap, and since the damping device is arranged in a recessed manner in the region of an end of the fitting body, or since alternatively the damping device is embedded in a wall of the piece of furniture, substantially parallel to an end region of the guide slot of the fitting body, the damping device does not project laterally beyond the fitting body. The fitting system thus has only a shallow depth and can be embedded in the walls, in particular side walls, of the piece of furniture without weakening or piercing the walls in an undesirable manner.

The damping device preferably comprises a damping cylinder comprising an extendable piston rod, and the damping device can be actuated in that, by means of the guide pin of the closure flap, the piston rod is inserted into the damping cylinder or withdrawn therefrom.

A damping device of this type provides a defined damping distance and a defined counterforce or damping force. Damping generally takes place in that, when the piston rod is moved, a fluid inside the damping cylinder is displaced and/or a spring arranged inside the damping cylinder is deformed. The piston rod is biased such that it is urged back into its starting position when the guide pin of the closure flap is removed.

The end position of the damping device preferably also determines the end position of the closure flap. In this case, a separate end stop is not required for the closure flap. However, it is also conceivable for the closure flap to be uncoupled from the damping device shortly before reaching its end position and thus moved against an end stop with a greater closing force.

The fitting body preferably has a substantially U-shaped cross-section comprising two side walls, a back wall and an open side oriented towards the front of the fitting body. The guide slot is formed by two opposing inner faces of the side walls. As a result, the fitting body can be implemented in a very compact manner and can also be embedded in an accordingly provided recess of a side wall of the piece of furniture, such that the loss of storage space in the piece of furniture is minimal.

The fitting system preferably comprises a position adjustment device for the damping device. The position adjustment device is embedded in the fitting body and designed to adjust the position of the damping device relative to the fitting body. The damping device preferably rests against the position adjustment device.

By adjusting the position of the damping device via the position adjustment device, the position of the closure flap in its end position can thus also be adjusted, such that for example in the end position the closure flap is arranged with uniform spacing from the body of the piece of furniture over its entire extent.

The position adjustment device may be implemented for example by a cam which is integrated below the damping device in the fitting body or is inserted into a recess in the wall of the piece of furniture. The cam has an axis about which the cam is rotatably mounted. By rotating the cam about this axis of rotation, the position of the damping device relative to the fitting body is varied owing to the contact between the cam and an end face of the damping device.

The damping device is preferably releasably connected to the fitting body. This ensures that different damping devices having different degrees of hardness or having different damping forces can be used. The fitting system according to the invention can thus be used for different closure flap geometries and closure flap weights, since only the damping device needs to be exchanged and adapted to the corresponding closure flaps.

The damping device can preferably be releasably connected to the fitting body by a snap connection. For this purpose, the fitting body has an undercut in cross-section in the end region, that is to say the side walls which define the receiving space for the damping device engage the damping device from behind and thereby fix it in the receiving space. For the snap connection it is also necessary for at least part of the damping cylinder and/or part of the fitting body to be resilient in the region of the undercut. As a result, the damping cylinder can be pushed into the fitting body via the open side thereof, and the undercut then fixes the damping cylinder.

This design of the fitting system allows easy exchange of the damping device. Furthermore, there is no need for an additional holding device for the damping device in the fitting body, and therefore the fitting body can be produced cost-effectively.

The cross-section of the fitting body in the region in which the damping device is provided is preferably substantially the same as the cross-section of the fitting body in which the guide slot is provided. As a result, the fitting body can be designed in a particularly simple manner and consequently produced particularly cost-effectively. The transverse extension of the cross-section of the fitting body in the region in which the damping device is provided can be either larger or smaller than the transverse extension of the cross-section of the fitting body in the region in which the guide slot is provided, such that it is possible to revert to existing damping devices.

The invention will be described in more detail below with reference to drawings, in which:

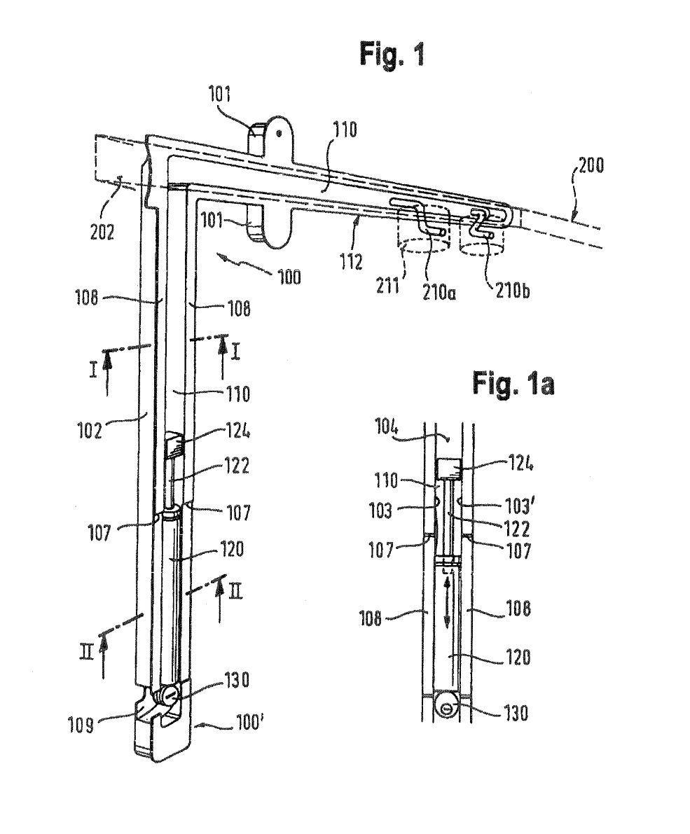

FIG. 1 is a schematic three-dimensional view of the fitting system according to the invention with a closure flap in the open position;

FIG. 1a is a side view of part of the fitting system according to the invention with an integrated and extended damping device;

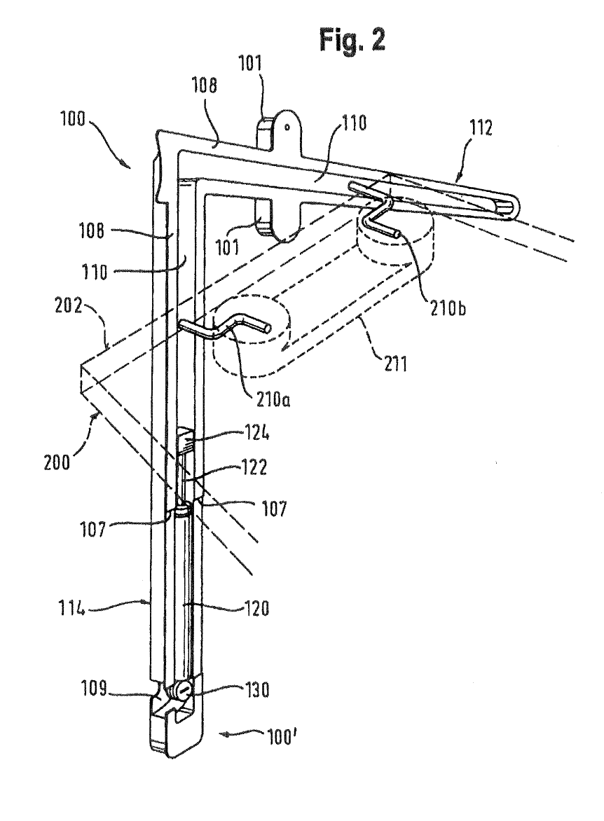

FIG. 2 shows the fitting system shown in FIG. 1, the closure flap being in an intermediate position between a starting position and an end position;

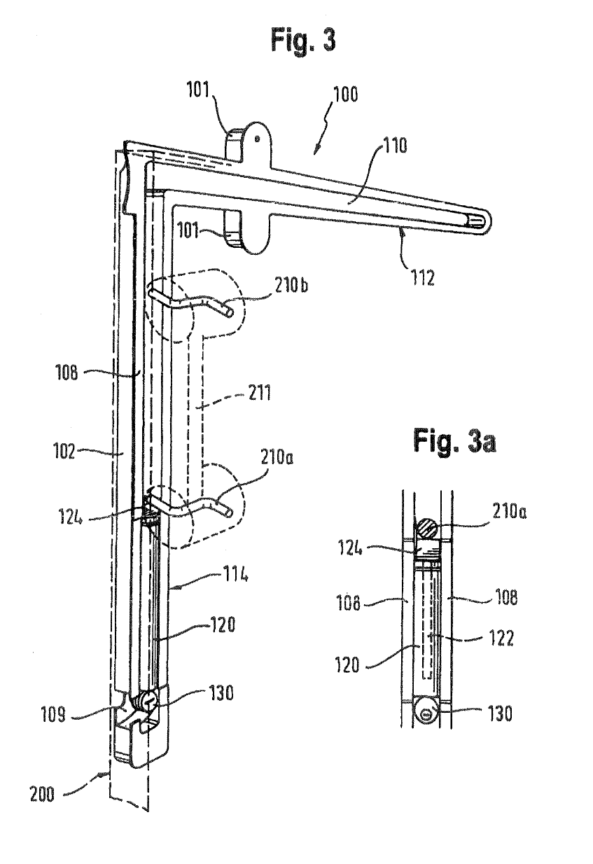

FIG. 3 shows the fitting system shown in FIGS. 1 and 2, the closure flap being in an end position;

FIG. 3a is a side view according to FIG. 1a, the damping device being in its compressed end position; and

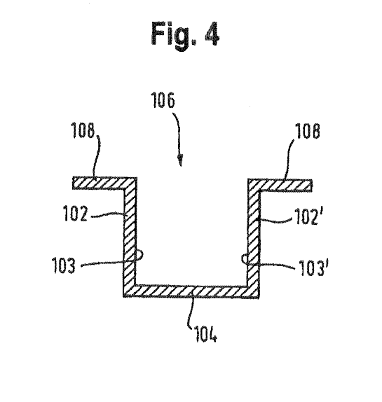

FIG. 4 is a schematic cross-section of the vertical arm of the fitting body along the line I-I

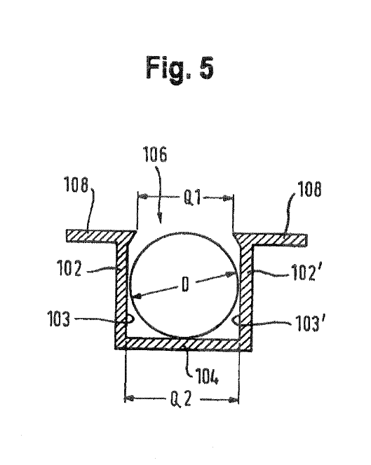

FIG. 5 is a schematic cross-section of the fitting body in the end region with inserted damping cylinder, along the line II-II from FIG. 1.

In the following description, it is assumed that a piece of furniture (not shown), in particular a cupboard or container, comprises two vertically oriented side walls, a horizontally oriented bottom panel and a horizontally oriented top panel. The side walls, the bottom panel and the top panel enclose a storage space which can be closed by means of a closure flap 200. In this closed position of the closure flap 200, said flap is oriented perpendicular to the side walls, the bottom panel and the top panel of the cupboard or piece of furniture.

FIG. 1 shows a fitting system according to the invention for guiding a closure flap 200 in a side wall of a piece of furniture of this type. A corresponding fitting system configured mirror-symmetrically is provided in the opposing side wall of the piece of furniture, such that the closure flap 200 is guided analogously in its two side regions.

The fitting system comprises a fitting body 100, which in FIG. 1 is L-shaped with a first arm 112 and a second arm 114. The fitting body 100 can be embedded in a recess of a side wall of the piece of furniture. In the following it is assumed that the fitting body 100 is embedded in the side wall of the piece of furniture such that the first arm 112 extends parallel to a horizontal upper edge of the side wall, such that in the mounted state the first arm 112 also has a horizontal orientation. The second arm 114 then extends parallel to a vertical front edge of the side wall, such that in the mounted state and when the piece of furniture is oriented accordingly the second arm 114 also has a vertical orientation.

The fitting body 100 shown in FIG. 1 has a substantially U-shaped cross-section. FIG. 4 shows a section in the plane I-I of the fitting body 100. The U-shaped cross-section has two side walls 102, 102′, a back wall 104 and an open side 106 oriented towards the front of the fitting body 100. The two opposing inner faces 103, 103′ of the two side walls 102, 102′ form a guide slot 111 of the fitting body 100. In the fitting body 100 shown in FIG. 1, the guide slot 110 extends in the horizontally oriented first arm 112 and in the second arm 114 extending perpendicular thereto, such that the guide slot extends in an L-shaped, angled manner.

The guide slot 111 is designed to receive guide pins 210a, 210b which are fastened in side regions 202 of the closure flap 200 and project laterally beyond the closure flap 200. As is clear from FIGS. 1 to 3, the guide pins 210a, 210b are S-shaped. One end of the guide pins 210a, 210b is guided in the guide slot 110 of the fitting body 100, while the other end of the guide pins 210a, 210b is fastened in a bracket element 211 which is made for example of plastics material or metal and is anchored in the side region 202 of the closure flap 200 and embedded therein at least in part.

In the view in FIG. 1, the closure flap 200 is in a starting position or in an open position in which the two guide pins 210a, 210b are guided in the upper, horizontally oriented first arm 112 of the fitting body 100. In this position the closure flap 200 is oriented horizontally and arranged just below the top panel of the piece of furniture.

Owing to the U-shaped cross-section of the fitting body 100, said body can be inserted into recesses accordingly provided for it in the side walls of the piece of furniture, such that the fitting system does not project or projects only slightly from the inner face of the side wall of the piece of furniture. In order that the fitting system is not inserted arbitrarily deep into the recesses accordingly provided in the side walls of the piece of furniture, supports 108 are provided on the fitting body 100 and extend approximately perpendicular to its side walls 102, 102′.

A fastening member 101 is provided in the first arm 112, oriented horizontally in FIG. 1, of the fitting body 100, which member is inserted into a corresponding recess of the side wall of the piece of furniture and can be screwed to the side wall.

The fitting system further comprises a damping device which is formed by a damping cylinder 120 comprising an extendable piston rod 122. The damping device 120, 122 is inserted into the fitting body 100 in the region of an end 100′ of the second arm 114. A damper head 124 having an enlarged cross-section compared to the cross-section of the piston rod 122 is mounted at the free end of the piston rod 122. The piston rod 122 and the damper head 124 project into the guide slot 110 of the fitting body 100.

FIG. 1a is a side view of part of the second arm 114 of the fitting body 100. The piston rod 122 and the damper head 124 project into the guide slot 110, since the piston rod 122 is in an extended state.

FIG. 2 shows the fitting system shown in FIG. 1, the closure flap 200 being in an intermediate position between the starting position shown in FIG. 1 and an end position. When the closure flap 200 is in the intermediate position, which is reached by pulling the closure flap 200 out of the body of the piece of furniture and subsequently lowering the closure flap 200, the guide pin 210a is located in the guide slot 110 arranged in the second arm 114, whereas the other guide pin 210b is guided in the guide slot arranged in the first arm 112. Owing to this arrangement of the guide pins 210a, 210b in the guide slot 110, the closure flap 200 has an oblique orientation. The orientation of the closure flap 200 changes in accordance with the relative positions of the guide pins 210a, 210b in the guide slot 110.

FIG. 3 shows the fitting system shown in FIGS. 1 and 2, the closure flap 200 being in an end position. The end position of the closure flap 200 is reached by pulling/pushing the closure flap 200 out of the intermediate position shown in FIG. 2 and somewhat further downwards towards the bottom panel of the cupboard, whereupon the closure flap 200 then slides into its closed end position owing to its weight alone. The guide pin 210a moves towards the damping device 120, 122, and the other guide pin 210b is guided in the guide slot 110 arranged in the first arm 112 towards the guide slot 110 arranged in the second arm 114. Before the end position of the closure flap 200 is reached, the guide pin 210a of the closure flap 200 comes into contact with the damper head 124. A weight of the closure flap 200 is exerted on the damper head 124 and thus on the piston rod 122 via the guide pin 210a. Owing to the weight of the closure flap 200, the piston rod 122 is slid into the damping cylinder 120. The damping device exerts a counterforce on the guide pin 210a, which counterforce is smaller than the weight exerted on the damping device 120, 122 by the guide pin 210a, such that the closure flap 200 is transferred into the end position at a reduced speed.

FIG. 3a is a side view of the second arm 114 of the fitting system, the damping device being in the maximally compressed position and thus in its end position. In this end position the damper head 124 forms an end stop for the closure flap 200, which is then in its vertical closed position.

The fitting system shown in FIGS. 1 to 3a further comprises a position adjustment device 130 in the form of a cam 130. The position adjustment device 130 is embedded in the fitting body 100 and is designed to adjust the position of the damping device 120, 122 in the fitting body 100. For this purpose, the damping cylinder 120 is received in the fitting body 100 in a longitudinally displaceable manner. The position adjustment device 130 is arranged directly below the damping cylinder 120 such that the lower end face of the damping cylinder rests on the position adjustment device 130. Owing to the eccentric configuration of the position adjustment device 130, the position of the damping cylinder 120 in the fitting body 100 can be varied by a rotation of the position adjustment device 130 about an axis of rotation oriented perpendicular to the back wall 104 of the fitting body 10, such that as a result the position of the closure flap 200 in relation to the piece of furniture can also be adjusted.

The position adjustment device 130 can be introduced into the fitting body 100 via a laterally arranged cavity 109 of the fitting body 100.

FIG. 1, 1a and 2 show that the fitting body 100 is provided with a shoulder 107 in the end region 100′ at the level of the end of the damping cylinder 120 remote from the position adjustment device 130. Owing to the shoulder 107, the fitting body 100 has a smaller depth extension in the end region 110′ than in the remaining region of the fitting body 100. In the end region 110 a cover can be mounted in front of the damping cylinder 120, such that the damping cylinder 120 cannot be seen from outside. The support 108 of the fitting body 100 preferably transitions flush into the corresponding cover.

FIG. 5 shows that the fitting body 100 has an undercut in cross-section in the end region 100′, such that a first transverse extension Q1 of the open side 106 of the fitting body 100 is slightly smaller than a diameter D of the damping cylinder 120. In addition, a second extension Q2 of the fitting body 100 is the same size or larger than the diameter D of the damping cylinder 120, at least in part, such that the damping cylinder 120 is accommodated between the side walls 102, 102′. The damping cylinder 120 and/or a part of the fitting body 100 in the region of the undercut and thus in the end region 100′ is/are resilient, such that the damping device in the form of the damping cylinder 120 and the piston rod 122 can be pushed into the U-shaped profile of the fitting body 100 and the damping device 120, 122 is releasably connected to the fitting body 100 by a snap connection.

Owing to the releasable connection between the damping device 120, 122 and the fitting body 100, the damping device can be exchanged for another damping device, or a fitting body can be retrofitted with a damping device 120, 122. The damping device 120, 122 can be tipped out of the fitting body 100 about an axis of rotation (not shown in the figures) oriented perpendicular to a side wall 102, 102′ of the fitting body 100.

### LIST OF REFERENCE NUMERALS

100 fitting body
100′ end region (of the fitting body)
101 fastening member (of the fitting body)
102, 102′ side wall (of the fitting body)
103, 103′ inner face (of the side wall of the fitting body)
104 back wall (of the fitting body)
106 open side (of the fitting body)
107 shoulder
108 support (of the fitting body)
109 cavity (of the fitting body)
110 guide slot
112 first arm
114 second arm
120 damping cylinder (of the damping device)
122 piston rod (of the damping device)
124 damper head (of the damping device)
130 position adjustment device, cam
200 closure flap
202 side region (of the closure flap)
210a, 210b guide pin
211 bracket element
D diameter of the damping cylinder
Q1 first transverse extension
Q2 second transverse extension

1. Fitting system for guiding a closure flap of a piece of furniture, comprising a fitting body which can be fastened to and/or in a wall of the piece of furniture, the fitting body comprising an angled or bent guide slot for receiving guide pins which are provided in side regions of the closure flap, the fitting system having the following features:
in an end region of the fitting body a damping device is embedded in the fitting body or in the wall of the piece of furniture, substantially parallel to an end region of the guide slot;
a guide pin of the closure flap can be brought into contact with the damping device; and
a weight of the closure flap, exerted via the guide pin, can be applied to the damping device over a damping distance when the closure flap is transferred into an end position and the damping device exerts a counterforce on the guide pin, which counterforce is smaller than the weight exerted on the damping device by the guide pin,
the fitting system being characterised in that the fitting body has an undercut in cross-section in the end region and is resilient in the region of the undercut, such that the damping device is releasably connected to the fitting body by means of the undercut.

2. Fitting system according to claim 1, characterised in that the damping device comprises a damping cylinder comprising an extendable piston rod and can be actuated in that, by means of the guide pin of the closure flap, the piston rod is inserted into the damping cylinder or withdrawn therefrom.

3. Fitting system according to claim 1, characterised in that the damping device transferred into an end position forms an end stop for the closure flap.

4. Fitting system according to claim 1, characterised by the following further features:
the fitting body has a substantially U-shaped cross-section comprising two side walls, a back wall l and an open side oriented towards the front of the fitting body; and
the guide slot is formed by two opposing inner faces of the two side walls.

5. Fitting system according to claim 1, characterised by the following features:
a position adjustment device for the damping device is embedded in the fitting body and designed to adjust the position of the damping device relative to the fitting body; and
the damping device rests against the position adjustment device

6. Fitting system according to claim 2, characterised by the following features:
a first transverse extension (Q1) of an open side of the fitting body the end region is slightly smaller than a diameter (D) of the damping cylinder;
a second transverse extension (Q2) of the fitting body in the region of the undercut is the same size or larger than the diameter (D) of the damping cylinder, at least in part.

7. Fitting system according to claim 1, characterised in that the region of the fitting body in which the damping device is provided is a straight prolongation of the guide slot.

8. Fitting system according to claim 1, characterised in that the cross-section of the fitting body in the region in which the damping device is provided is substantially the same as the cross-section of the fitting body in which the guide slot is provided.

9. Fitting system according to claim 1, characterised in that the damping device can be tipped out of the fitting body about an axis of rotation oriented perpendicular to a side wall of the fitting body.

10. Piece of furniture comprising:
two side walls;
a closure flap comprising two side regions for closing an opening of the piece of furniture;
two guide pins in each side region of the closure flap,
characterised by the following further features:
a fitting system according to claim 1 is mounted in or on the side walls of the piece of furniture or embedded in predetermined recesses; and
the two guide pins arranged at each side region, of the closure flap are guided in the respective guide slots.
